(19) United States
(12) Patent Application Publication
(10) Pub. No.: US 2010/0100422 A1
(43) Pub. Date: Apr. 22, 2010

(54) APPARATUS AND METHODS FOR PRICING GUARANTEED DELIVERY CONTRACTS

(75) Inventors: Michael A. Schwarz, Berkeley, CA (US); R. Preston McAfee, San Marino, CA (US); Sai-Ming Li, Santa Clara, CA (US); Jonathan D. Levin, Stanford, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/255,896

(22) Filed: Oct. 22, 2008

(51) Int. Cl. G06Q 90/00; G06Q 30/00; G06Q 20/00; G06F 17/30

(52) U.S. Cl. 705/10; 705/400; 705/14.53

(57) ABSTRACT

Disclosed are apparatus and methods for pricing on-line advertisement inventory. In one embodiment, a method for pricing on-line advertisement inventory includes (i) forecasting a delivery cost for delivering a plurality of deliverable impressions to meet a guaranteed delivery contract for a particular advertising product; and (ii) determining a target price for a guaranteed delivery contract for such particular advertising product by adjusting the delivery cost based on one or more changes in one or more conditions of a supply and demand market.

### BACKGROUND OF THE INVENTION

The present invention is related to on-line advertising. It especially pertains to techniques and mechanisms for pricing on-line advertisement inventory.

For many web portals and Internet Service Providers (ISPs), advertising is a major source of revenue. One form of advertising involves showing advertisers' advertisement banners on web sites that are being visited by users. For example, a preeminent portal such as Yahoo! displays advertisers' advertisements on one or more associated web sites that are viewed by users. In return, the advertisers pay a fee for each advertisement or a predefined number of advertisements viewed by web users. Contracts to show advertisements are normally signed several weeks or months before advertisements get delivered and are often expressed in terms of page views. The duration of contracts typically ranges from one day to multiple years.

A significant portion of advertising contracts is in the form of guaranteed delivery bookings. A guaranteed booking specifies an agreement between the advertisement seller or portal and an advertiser. For example, a guaranteed booking specifies the price and the quantity of inventory, as well as the user target profile, to be delivered under the contract in advance of the advertisement being delivered or displayed.

In order to improve the efficiency of the marketplace, a pricing mechanism that reflects a true underlying value of the inventory delivered is needed. If a particular inventory is overpriced, the advertisers may become dissatisfied. Conversely, if a particular inventory is under-priced, revenue opportunities would be lost. Accordingly, it would be beneficial to provide appropriate pricing of such on-line advertising inventory.

### SUMMARY OF THE INVENTION

Accordingly, apparatus and methods for pricing on-line advertisement inventory are disclosed. In one embodiment, a method for pricing on-line advertisement inventory includes (i) forecasting a delivery cost for delivering a plurality of deliverable impressions to meet a guaranteed delivery contract for a particular advertising product; and (ii) determining a target price for a guaranteed delivery contract for such particular advertising product by adjusting the delivery cost based on one or more changes in one or more conditions of a supply and demand market.

In a specific implementation, forecasting the delivery cost is based on historical data from an exchange market in which impressions are sold. In a further aspect, the exchange market includes the selling of impressions for guaranteed delivery (GD) contracts and impressions that are not applied to guaranteed delivery contracts. In yet a further aspect, the method includes applying to each deliverable impression a statistical model for determining a delivery cost of an individual impression in the exchange market as a function of such individual impression's user target attributes based on historical bookings for a plurality of historical impressions. The delivery cost of the advertising product is forecast by averaging the delivery costs for the deliverable impressions as determined by the statistical model.

In one embodiment, the delivery cost is scaled up by a premium factor so as to account for additional value of inventory for GD contracts vs. NGD contracts. In another aspect, the delivery cost is adjusted in response to historical and current booking rates for the advertising product and/or adjusted in response to one or more demand elasticity estimates for the advertising product.

In another embodiment, the determined target price, which was based on historical bookings, is used to determine a current target price of the new product, and the current target price of the new product is returned for use in a booking negotiation with a potential buyer of such new product.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of embodiments of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a flow chart illustrating a procedure for determining the price of a new product for a guaranteed contract in accordance with one embodiment of the present invention.

FIG. 3 is a diagrammatic representation of a price determination system in accordance with a specific implementation of the present invention.

FIG. 4 is a flow chart illustrating a process for generating a statistical model for determining an individual impression's delivery cost for a GD contract in a unified exchange market in accordance with one embodiment of the present invention.

FIG. 5 illustrates an example computer system in which specific embodiments of the present invention may be implemented.

### DETAILED DESCRIPTION OF SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that they are not intended to limit the invention to these specific embodiments. On the contrary, such description is intended to cover alternatives, modifications, and equivalents as may be included within the spirit and scope of the invention as defined by the appended claims. In the following description, numerous specific details are set forth in order to provide a thorough understanding of embodiments of the present invention. Embodiments of the present invention may be practiced without some or all of these specific details. In other instances, well known process operations have not been described in detail in order not to unnecessarily obscure embodiments of the present invention.

### Overview

In general, mechanisms for valuing advertising inventory for guaranteed contracts are provided herein. Advertisement sellers and advertisers typically specify the product of transaction in terms of web property, position, and one or more specified user targeting parameters. A guaranteed contract for a specific product at a specific price to be delivered during the specified time frame may be agreed upon by the advertisement sellers and an advertiser. The individual advertisement displays that are (or can be) delivered to meet an advertiser's guaranteed contract specifications may also be referred to as individual impressions.

A web property may pertain to one or more web sites or a set of related web sites (e.g., a Finance web property). Sub-properties (e.g., a mutual fund web page from a Finance web property having multiple web pages) may also be specified. A property position may correspond to any suitable location with respect to displaying an advertisement in a particular property or sub-property. Examples of positions may correspond to particular relative positions or sections on a web page (e.g., top, bottom, or side). In some alternative embodiments, an advertiser may also specify one or more event specifications. An event specification, during which the corresponding advertisement is to be displayed, may pertain to a time or time duration (e.g., time of day or within a specified time-of-day window for displaying the advertisement) or one or more particular events (e.g., after occurrence of a user activity, such as performing a search in a Search property or sending an email).

A user targeting parameter may include any user characteristic that an advertisement may wish to target for advertisement purposes. User targeting parameters may include a geographical location or area, an age range, a gender, an income range, an educational level, one or more interest categories, one or more behavior characteristics, etc. Behavior characteristics may relate to tracked user activity (e.g., via user cookies), such as users that have visited specified sites, users that have visited specified sites more than a specified frequency, etc.

Pricing of guaranteed delivery contracts in online adverting industry is often complicated by the high number of overlapping products, different values created by the different impression matchings between products and advertisers, and different advertiser buying behaviors. A standard optimization-based approach for pricing such products is not suitable and tends to be impractical. Furthermore, a pricing approach that will work in a unified exchange marketplace for purchasing impressions for both guaranteed delivery (GD) contracts and non-guaranteed delivery (NGD) contracts is needed.

One industry practice is to set prices based on the specific property or property position and add mark-ups on top of this base price for certain targeting specifications. In other words, each property and/or property position combination may be priced separately. This approach works well when products are disjoint and the substitutability between the different products is fairly well understood. However, as targeting technology becomes more mature and advertisers have evolved from purchasing page views to purchasing a specified audience, this pricing model may no longer suffice for yield optimization.

Furthermore, as advertisement systems evolve towards a unified exchange marketplace for both GD and NGD demand, there may be a significant opportunity to improve the pricing of GD contracts. Specifically, a unified exchange environment may differ from a non-unified exchange (only NGD) in one or more of the following ways: (1) all GD and NGD inventory is exposed in the exchange, so that market prices may be highly informative about the value of inventory; (2) advertisers may utilize multiple avenues to obtain inventory, potentially lowering the guaranteed premium and share of revenue from GD sales; (3) a sophisticated delivery approach may allow the fulfillment of GD contracts to be sensitive to current market prices; and (4) data collection and instrumentation may allow close monitoring of the costs of delivering guaranteed contracts and their performance.

In general, certain embodiments of the present invention include pricing mechanisms that address and/or anticipate the market changes and features listed above. Although certain embodiments are described herein in relation to particular targeting parameters or impression attributes (such as specified web properties and user demographics), any suitable advertisement scheme may be utilized by an advertiser for displaying a particular advertisement in any suitable manner to any suitable type of person in any suitable context.

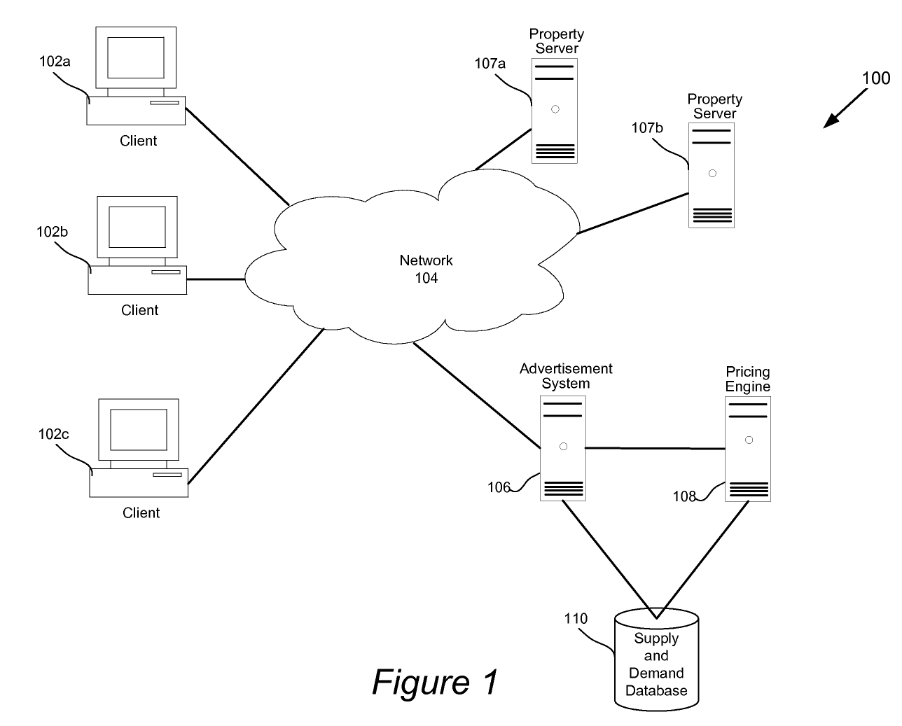

Prior to describing mechanisms for determining the price of a new product for a guaranteed contract, a computer network architecture will first be briefly described to provide an example context for practicing techniques of the present invention. FIG. 1 illustrates an example network segment 100 in which the present invention may be implemented in accordance with one embodiment of the present invention. As shown, a plurality of clients 102a˜102c may access one or more web property applications, for example, on property servers 107a and 107b via network 104 and/or access an advertisement service, for example, on advertisement system server 106. The advertisement system may operate in conjunction with a pricing engine 108 that is operable to determine the price of a specified product. The advertisement system 106 and pricing engine 108 (or servers) may have access to one or more supply and demand database(s) 110 into which supply and demand information is retained.

The network may take any suitable form, such as a wide area network or Internet and/or one or more local area networks (LAN's). The network 104 may include any suitable number and type of devices, e.g., routers and switches, for forwarding web property requests from each client to each web property server and forwarding web results back to the requesting clients or for forwarding data between various servers.

The invention may also be practiced in a wide variety of network environments (represented by network 104) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

Each web property application may implement any type of web service that is provided by a particular service provider (e.g., Yahoo! Inc. of Sunnyvale, Calif.), such as Yahoo! Answers, Yahoo! Autos, Yahoo! Finance, Yahoo! Games, Yahoo! Groups, Yahoo! HotJobs, Yahoo! Maps, Yahoo! Movies/TV, Yahoo! Music, Yahoo! Personals, Yahoo! Real Estate, Yahoo Shopping, Yahoo! Sports, Yahoo! Travel, Yahoo! Yellow Pages, Yahoo! Local, Yahoo! Search, Yahoo! Email, etc. Each property application may be utilized by a user (human or automated), e.g., on clients 102a˜102c. Additionally, each web property may correspond to any suitable number and type of web pages or other web objects (e.g., video, audio streams, photographs, etc.).

Advertisement salespeople who sell guaranteed contracts to advertisers may interact with advertisement system 106 (e.g., via client 102a and through network 104). In one embodiment, a salesperson may issue a query to advertisement system 106 regarding a specified product or target. For example, the product may be specified for a particular web property, e.g., the Yahoo! email web property, a specified position for the advertisement to be displayed in such property, and particular demographics, e.g., California males who like sports and autos. The advertisement system 106 may then obtain a price for such specified product (e.g., from pricing engine 108), obtain inventory availability information (e.g., from supply and demand database 110), and return the available inventory information and price to the querying salesperson (e.g., to client 102 via network 104). The salesperson may then book a guaranteed contract accordingly (e.g., with advertisement system 106 via network 104). The advertisement system 106 then operates to fill the booking (guaranteed contract) by providing the number of requested impressions (e.g., via a property server) at the negotiated price during the contract period.

Embodiments of the present invention may be employed with respect to any provider of one or more web property applications and advertisement system, and example providers include Yahoo! Inc., Google Inc., Microsoft Corp., etc. A plurality of web property applications, an advertisement system, and a pricing engine may be implemented on any number of servers although only one advertisement system 106, one pricing engine 108, and two web property servers 107a and 107b are illustrated for clarity and simplification of the description.

### Pricing Embodiments

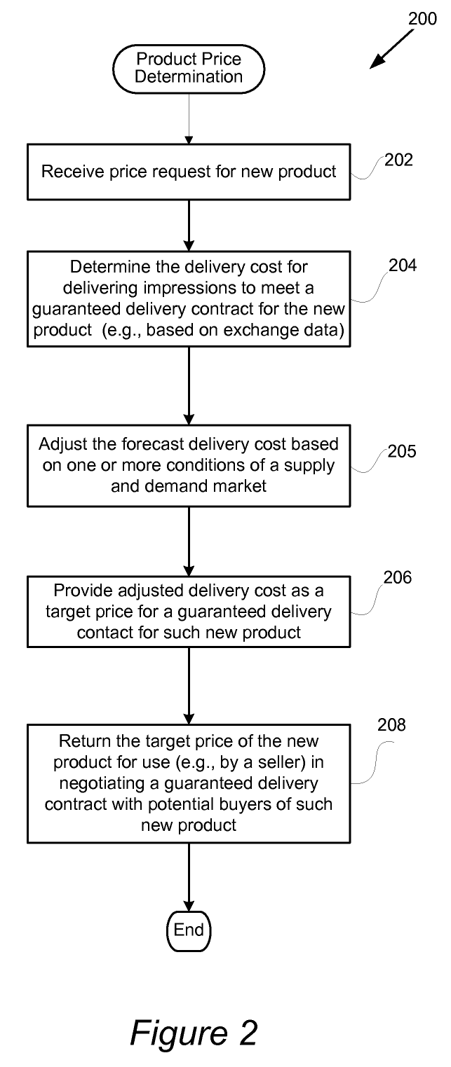

Regardless of the specific architecture, any suitable mechanism for determining the price of a specified product for a guaranteed contract may be provided. FIG. 2 is a flowchart illustrating a procedure 200 for determining a product price in accordance with one embodiment of the present invention. Initially, a price request for a new product may be received in operation 202. For instance, a salesperson sends a request for a new product that is directed towards a particular type of user target or set of specified user target attributes for displaying an advertisement, such as advertising to all users of the Yahoo! Finance property who have income levels above $50,000. The request may also specify a flight date (e.g., date at which advertisement campaign commences), time duration, and number of impressions to be guaranteed for such time duration. Although the pricing techniques may be implemented with respect to a requested product, the pricing mechanisms described herein may be implemented with respect to a product that has not yet been requested or has been requested in the past and a more up-to-date price is desired. Additionally, the following pricing techniques may be applied to any number and type of advertisement products.

The delivery cost for delivering impressions to meet a guaranteed delivery contract (e.g., the requested guaranteed delivery contract and/or a future GD contract) for the new product may then be determined or forecast in operation 204. In one embodiment, the delivery cost is based on historical data from a unified exchange market in which impressions are sold for GD and NGD contracts. For example, the exchange data may be used to predict the cost of delivering an impression for a guaranteed delivery contract for the particular product. A specific implementation that utilizes a statistical model for determining an exchange price for each deliverable impression is further described herein. The exchange prices of the deliverable impressions may then be averaged together to determine a delivery cost of the corresponding new product or GD contract.

The determined delivery cost may then be adjusted based on one or more changes in one or more conditions of a supply and demand market in operation 205. For instance, the forecast delivery cost may be adjusted in response to booking rates and/or demand elasticity estimates obtained from experimentation and historical data.

The adjusted delivery cost may then be provided as a target price for a guaranteed delivery contract for such new product in operation 206. The target price of the new product may then be returned for use (e.g., by the requesting salesperson) in negotiating a guaranteed delivery contract with potential buyers of such new product in operation 208. For example, the salesperson who requested the price may use such price as a minimum price that will be accepted in the contract negotiation. Alternatively, the salesperson who requested the price may offer such returned price to a user with whom she is negotiating a booking or retain such price information for later use with other potential buyers of the same new product.

Since impressions that are forecast for particular bookings may be reallocated, a new product's price may also be re-determined each time impressions are reallocated. Additionally, sales personal may be notified of new product prices so that they can negotiate bookings based on such new prices.

The determined product price may be said to be based on historical data and may be optionally adjusted for the current day or timeframe. For example, it may be determined that the current day has historically had lower or higher prices and the determined price may be adjusted accordingly to generate a current price that is more accurate for the current day.

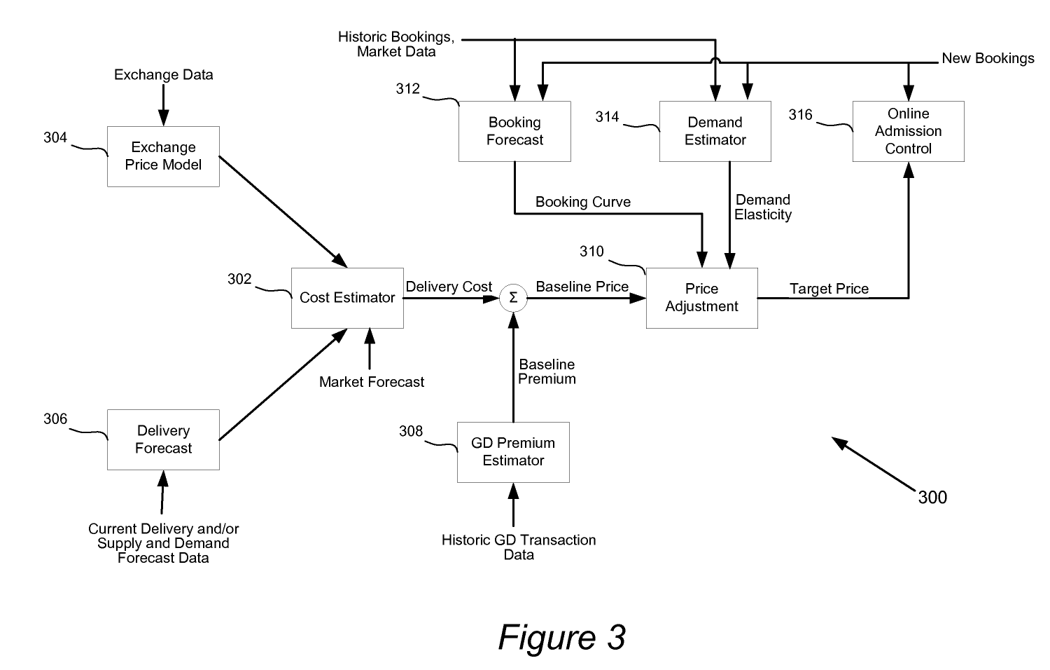

FIG. 3 is a diagrammatic representation of a price determination system 300 in accordance with a specific implementation of the present invention. The price determination system may include a cost estimator 302 for estimating an expected delivery cost of a contract based on the expected cost of purchasing the delivered impressions in an exchange market. In general, a bid agent may handle guaranteed contracts by purchasing impressions in the exchange for such guaranteed contracts. In one environment, the delivery cost may correspond to the opportunity costs of buying impressions for the contract, rather than selling the same inventory into the open or spot (non-guaranteed delivery advertisers) market.

The cost estimator 302 may receive input from a delivery forecast module 306 which forecasts the impressions to be delivered for a given contract based on current delivery and/or supply and demand forecast data. The cost estimator 302 may also utilize an exchange price model 304 for estimating an exchange price for the forecast impressions to be delivered for the given contract. In general, the expected delivery and expected prices are combined to get an expected delivery cost for a particular product.

A statistical exchange model 304 can be generated to estimate an expected auction price and expected variance of such price as a function of individual impression characteristics. In other words, a projection of price may be estimated based on sale characteristics by the exchange model. The statistical exchange model 304 may yield a predicted exchange price of e(X) as a function of impression and market characteristics X. The cost estimator 302 may also receive market forecast data of future market conditions that can be input into the exchange model to generate predicted delivery prices as a function of impression characteristics. Forecasting future market conditions may utilize additional information about future supply conditions, such as a supply forecast and an estimate of guaranteed bookings. Future market conditions in the exchange may be extrapolated from current trends.

An exchange model may also be useful for understanding the sources of value in particular inventory. For example, in financial markets, statistical models of pricing along the proposed lines are used to uncover drivers of stock returns and build trading strategies. A statistical exchange model for estimating exchange prices may be similarly useful for helping to develop valuable advertising products.

In general, the exchange model for determining a delivery cost of an individual impression may depend on a set of p model parameters and a set of α impression attributes. Each individual impression delivery cost, νᵢ, may be expressed as any suitable combination of such individual impression's attributes, e.g., α₁˜αₙ, and one or more model parameters, e.g., p₁˜pₙ. The model for an individual impression delivery cost, νᵢ, may also be linear or nonlinear.

In a very simplified example, a linear model may be used for each individual impression delivery cost, νᵢ, where the model is a function of four impression attributes pertaining to property, gender, state of residence, and income level, as well as four associated model parameter values equal to $0.50, $0.25, $0.25 and $0.50, respectively:

νᵢ=$0.50×I(property=Finance)+$0.25×I(gender=male)+$0.25×I(state=CA)+$0.50×I(income>$10,000) [1]

where the function I( ) is equal to 1 if the condition in the parenthesis is true and is equal to 0 if the condition is false. For a first impression that is presented in a Finance property to a male user who has an income above $50,000 and resides in California, the delivery cost of such first impression is equal to $1.50 (0.50+0.25+0.25+0.5). For a second impression that is presented in a Finance property to a female user who has an income above $50,000 and resides in the state of New York, the delivery cost is equal to $1.00 (0.5+0+0+0.5). For a third impression that is presented in a Finance property to a person with unknown gender and an income above $50,000 and has an unknown state of residence, the delivery cost is $1.00 (0.5+0+0+0.5).

Although the model illustrated by expression [1] only includes three attributes, a model would typically pertain to a higher number of different attributes. For instance, the model may include a plurality of model parameter values that each depends on one or more attribute values that include any combination of user targeting attributes as described herein. Examples of user target attributes may include property (which may specify a sub-property), one or more specified position in one or more web properties, one or more timing or event specifications, and one or more of the following: a user geographical location or area, a user age range, a user gender, a user income range, a user educational level, one or more user interest categories, one or more user behavior characteristics, etc.

The delivery forecast module 306 may operate to forecast the type of impressions that will be delivered on a guaranteed delivery contract. The eligible impressions that can serve each booking request or new product may be determined using any suitable inventory forecasting technique for predicting inventory for a requested product. Several techniques for predicting inventory are described further below. In one implementation, current delivery patterns may be used as a proxy for future delivery. That is, the delivery on guaranteed contracts may be tracked and such delivery may be tabulated. For example, delivery data may include a randomly selected sample of user visits to specific web properties and booked contracts that were active during such visit. By matching each impression to the relevant contract lines of advertisement that were shown on the visited page, a random sample of the impressions that were delivered may be obtained for each active contract line. The sample can be used as an estimate of the overall distribution of impression types.

The random sample of impressions can then be used in the statistical exchange model to assign a delivery cost to each impression. The impression delivery costs can then be summed for each booking so as to yield an estimate of both the actual cost of delivering the booking line and the future cost of delivering similar booking lines, assuming delivery patterns remain stable.

In a very simplified example, the above described impressions (i.e., 1. a finance property, male user who has income above $50,000 and resides in California, 2. a finance property, female user who has income above $50,000 and resides in New York, 3. a finance property user who has unknown gender and an income above $50,000 and unknown state of residence) may have been forecast to serve the new product for finance property users who have income above $50,000. If only the three impressions exemplified above were forecast to be available for the new product request, using the model of equation [1] would result in three delivery costs of $1.5 CPM, $1 CPM, and $1 CPM, respectively, as illustrated above. Of course, these numbers are merely illustrative and may each have much lower or higher values or be expressed in other units (e.g., cost per click or CPC).

The delivery cost of the new product or new booking may then be determined based on the average of the individual impression deliver costs. In a simplified expression, the new product's delivery cost, v, may be determined by the following expression:

$$v = \frac{1}{N} {\sum }_{i = i}^{N} {v}_{i} ( p , α ) \qquad [ 2 ]$$

where N is the number of forecast eligible impressions that have been determined to serve the new product, νᵢ is the delivery cost for each individual forecast impression as determined by the exchange price model, which was generated as a function of “p” and “α” parameters. As described above, the “p” parameters are model parameters, while the “α” parameters correspond to impression attributes, and each individual impression delivery cost is determined based on a model, e.g., such as a model similar to the expression [1].

A new product's delivery cost may generally depend on the individual delivery costs of the individual impression values that can serve such product, and these individual impression deliver costs depend on the attributes of such individual impressions. Different individual impression attributes will affect the delivery cost of such individual impression differently. That is, the model may be arranged such that different attributes of a particular individual impression result in different contributions to the particular individual impression's delivery cost. For instance, an attribute for a higher income may contribute more to the delivery cost of an impression than other attributes, such as attributes for a particular gender. The model may also be arranged such that different individual impressions with the same type of attribute, but having different delivery costs for such same attributes, result in different values for such different individual impressions. In the above example, the first impression has a gender attribute with a male value, which contributes $0.25 CPM to the impression value. In contrast, the second impression has a gender attribute with a female value, which contributes $0 CPM to the impression value. In other models, the female gender value may contribute a different nonzero CPM value to the impression value.

Additionally, since the forecast impressions will likely include other specified attribute values, in addition to the attributes specified by the new product, the new product's final value may more accurately account for values that advertisers have for certain attributes, even if such attributes are not specified by the advertisers of the new product or the advertisers of historical bookings.

Several alternative ways to estimate contract delivery cost may also be utilized. For example, exchange prices may be forecast and input into an allocation algorithm to solve for the expected delivery cost for a given contract line. Alternatively, exchange demand may be forecast, as well as inventory and contract bookings, and then used to solve for the expected delivery costs (e.g., expected exchange prices) on all contract lines at the same time. Either technique could yield expected delivery costs for booked contracts as an output. One advantage of the later approach is that it would rely on a structural model of exchange price determination so that if the forecasts of the underlying components were accurate, it might lead to more accurate predictions than a pure statistical forecast if there are large fluctuations in supply or demand. If the market is relatively stable, a statistical forecast may be simpler and work quite well.

After the delivery cost of a particular product is estimated, a guaranteed delivery (GD) premium estimator 308 may also determine a base line premium by which the initial delivery cost is scaled up based on historic (GD) transaction data. Advertisers may be willing to pay a premium for a guaranteed contract (vs. NGD inventory) for several reasons. A guarantee buy may (a) allow the advertiser to lock in inventory and price, (b) facilitate campaign planning by the advertiser; and/or (c) allow the advertisers to work with the sales force. Accordingly, a premium may be charged for guaranteed delivery that captures this additional value. For example, the delivery cost may be multiplied by a baseline premium value that is based on the additional value that is obtained by selling inventory to guaranteed contracts, as compared to selling such inventory on the spot market. For instance, the baseline premium may correspond to an average additional value for all inventory or particular types of inventory that overlap with the new product. In one example, if the new product pertains to a Finance web property, the baseline premium may be determined by taking an average additional value of selling all Finance property inventory to guaranteed delivery contracts.

In a specific implementation, the GD premium estimator 308 may use a statistical model for capturing the determinants of historical guaranteed prices. In particular, the model for determining a GD premium may be a similar “hedonic” model to what is described above for an exchange pricing model. Data from booked guaranteed contracts may be tracked so that data includes line characteristics (e.g. property, position, location, flight date, user targeting, frequency cap, etc.), purchaser characteristics, supply and market conditions, and also the line price and imputed line cost. With this historical GD transaction data, a statistical model of the guaranteed premium (price/cost) may be generated as a function of contract characteristics. Alternatively, a model of price may be simply estimated, with cost as one of the explanatory variables. If guaranteed prices become largely “cost-driven” under exchange integration, then the imputed contract cost will account for much of the variation in guaranteed pricing. The generated model can then be adjusted for changes in overall market or supply conditions, yielding a prediction of the premium that “would be” placed in the future should current pricing practice remain the same.

A price adjustment module 310 may also utilize a booking curve from booking forecast module 312 which represents how sold out a particular booking is. For example, guaranteed contracts may be sold over a six to twelve month period, and sometimes longer, prior to the “flight date”, which corresponds to the beginning of the delivery window. Bookings have been found to follow a fairly regular pattern. For instance, there are a substantial number of full-year contracts booked in December and January, and then sales for a given month ramp up slowly over time, so that, e.g. sales of June inventory are gradual through the winter and ramp up during the spring. To the extent this pattern still applies, it allows for gradual adjustment of target prices as booking rates to date are compared to the historical booking curve.

The simplest case to consider is for a product where it is desired to sell substantially all of such product inventory as guaranteed. Historically, many valuable products (such as key positions on the Finance page) may have sold out or achieve full sell-through. To achieve target full sell-through, prices can be adjusted adaptively from their baseline level as the full sell-through target get closer. If sales-to-date for a particular line are running above historical booking rates, this trend indicates that the particular line will sell out in advance of the flight date and the price can be raised so as not to sell out “too soon” and to maximize revenue. Conversely, sales below the historical booking curve indicate that lower prices may be needed to get back on the booking curve and achieve full sell-through. In a specific example if a booking of a particular product line becomes more than 90% sold more than a month before the flight date and past data indicates that this product lines has typically sold out only 50% by this time, the baseline price may be scaled up by a premium amount. Conversely, if the same product has only sold 20%, the baseline price may be scaled down so as to sell more quickly. The sold out and time thresholds at which a premium or discount is applied may vary for different types of inventory.

A demand estimator 314 may be operable to determine a demand elasticity that is also utilized by the price adjustment module 310 to adjust the baseline price. In general, the demand estimator may indicate a level of confidence for the particular baseline price. For example, time trends (e.g., people are more likely to enter bookings at the beginning of a month) or an event may temporarily affect the frequency of bookings and skew the data. Demand elasticity can generally define a measure of the sensitivity of quantity demanded to changes in price. In other words, elasticity measures the relationship as the ratio of percentage changes between quantity demanded of a good and changes in its price.

Various research techniques (e.g., test market or experimentation analysis, analysis of historical sales data, and conjoint analysis) may be utilized to determine demand elasticity for a particular product. For products that are potentially priced incorrectly, price experimentation can yield an estimate of demand elasticity and guide price adjustment. In a specific example, demand elasticity may be determined by (a) identifying products that are potentially priced incorrectly, (b) identifying “treatment” and “control” groups for a price experiment, and (c) varying target prices for the treatment group and compare sales.

Treatment and control groups may be identified in any suitable manner. In some cases, it may suffice to simply drop the target price on a product and observe demand in the month before and after in a randomly selected treatment group. The target price is kept constant for a randomly selected control group. The demand change in the treatment group can be compared to the demand change in the control group and used to calculate demand elasticity. Alternatively, to account for underlying time trends in demand or seasonal factors, a more sophisticated approach may be to randomize prices across quotes, or to identify a “comparable” product and use changes in its sales to adjust for time and seasonal trends.

Demand elasticity may also be estimated using historical sales data. Since the demand elasticity is a causal parameter, the change in sales is caused by a change in prices. If historical data is analyzed, it can be observed that prices and sales have moved around a lot for individual products, but in many cases prices may have been lowered in response to high or low anticipated demand. So a regression of sales on price may yield a historical correlation but may not correspond to demand elasticity. Moreover, demand and supply may be difficult to separate from each other. For example, if a small number of impressions are observed as being purchased for a given product (e.g., Finance impressions), it may be hard to know whether these low sales are due to the high price or to a lack of availability that limited purchase size.

In general, demand modeling is likely to be useful for providing directional guidance on prices, and perhaps most useful when combined with additional diagnostics. Data that would facilitate estimates of demand elasticity may be collected. Three pieces of information to incorporate into the booked contract data may include: (a) the target price at the time of the sale as well as the transaction price, (b) the available supply at the time of the sale; and (c) data from the RFP (request for proposal), including the advertiser's budget. The third piece of information, such as the advertisers' requests and stated budgets, may be particularly informative as they may reveal the “potential” demand for a product as well as the “realized” demand. In addition to facilitating estimates of demand elasticity, this data can provide a natural performance metric for guaranteed sales—the percent of advertiser budgets that is being capturing.

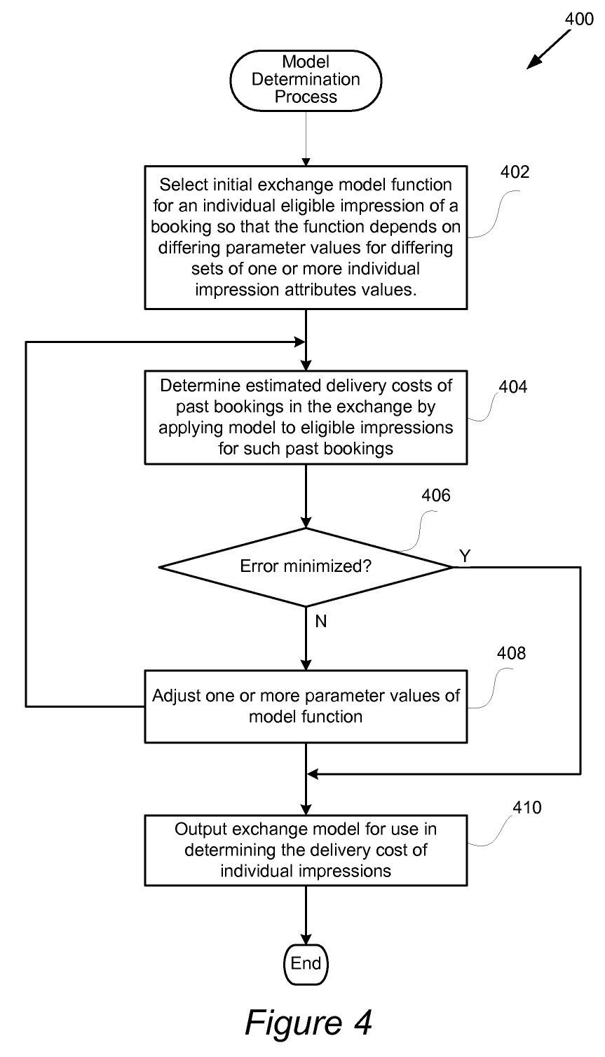

FIG. 4 is a flow chart illustrating a process 400 for generating a statistical model for determining an individual impression's delivery cost for a GD contract in a unified exchange market in accordance with one embodiment of the present invention. In general, any suitable technique may be used to generate a model that accurately estimates the delivery costs of individual impressions so that the estimated delivery costs are within a predefined error of actual prices (or delivery costs) paid for historical bookings and their associated impressions in an exchange market. Example iterative processes that may be utilized to generate such a model include a Nelder-Mead technique, a simulated annealing method, a genetic algorithm, or any suitable combination of such techniques, etc. For example, model parameter values that are associated with each set of one or more attribute values or range of attribute values may be adjusted in a linear equation (e.g., similar to equation [1]) for determining an impression price until the errors between the actual prices of historical bookings and the estimated total price for the individual estimated impression prices of such historical bookings are minimized.

Referring to the illustrated embodiment of FIG. 4, an initial model function is selected for an individual eligible impression of a booking so that the function depends on differing parameter values (e.g., p₁˜pₙ) for differing sets of one or more impression attribute values (α₁˜αₙ). In one implementation, for every possible attribute value (α₁˜αₙ), the following model may be used:

νᵢ=p₁×I(α₁)+p₂×I(α₂)+p₃×I(α₃) . . . +pₙ×I(αₙ) [3]

For example, parameter values p₁˜pₙ may be set to initial values for each set of impression attribute values (α₁ through αₙ). Each of parameter p₁˜pₙ may be set to any suitable initial values and may have the same or different values. Each impression attribute value may correspond to one or more possible values of one or more attributes. For instance, an attribute value may correspond to a particular one of a predefined set of values for a particular attribute. Thus, each particular attribute value, α, in the model would have a corresponding parameter value, p, which is how much value is contributed to the individual impression price based on whether or not such individual impression has the particular attribute value.

By way of example, the attribute gender may have three predefined values: male, female, unknown. In the above expression, α₁ may correspond to a “male” value for the gender attribute; α₂ may correspond to both a “female” attribute value for the same gender attribute; and α₃ may correspond to the “unknown” value for the same gender attribute. In this example, if the impression has a gender attribute matching the α₁ male value, the parameter value p₁ contributes to impression price (and the parameters p₂ and p₃ do not contribute). Likewise, the parameter value p₂ contributes to the impression price (and the parameters p₁ and p₃ do not contribute) if the impression has a gender attribute matching the α₂ female value, and the parameter value p₃ contributes to the impression price (and the parameters p₁ and p₂ do not contribute) if the impression has a gender attribute matching the α₃ unknown value. Thus, if a particular impression is presented to a male user, the parameter value p₁ contributes to the particular impression's price, while the parameter values p₂ and p₃ do not.

The model may not include a parameter value for certain attribute values of the same type of attribute. For example, the model may include a parameter value, e.g., p₁, for a male value of a gender attribute and a parameter, e.g., p₂, for a female value of the gender attribute, while not including a parameter value for an “unknown” gender value. Additionally, each parameter, p, may be associated with more than one type of attribute. For instance, a parameter value p₄ may correspond to both a male value for a gender attribute and a California value for a residence attribute. In a more illustrative example, the parameter value p₄ contributes to such impression's price only if an impression is presented to a male user who resides in California. These simple model examples are not meant to limit the scope of the present invention. More complex conditions and nonlinear functions may be used in a model to determine the delivery cost or price of an individual impression.

Referring back to FIG. 4, once an initial model is selected, estimated delivery costs of past bookings may be determined by applying the initial model to the eligible impressions for such past bookings in operation 404. For instance, the particular attributes of impressions that were actually used to serve (or have been forecast to serve) a particular booking may be input into the model to determine the estimated delivery costs of such impressions, and the estimated impressions delivery costs may be averaged to determine an estimated booking delivery cost. This process may be repeated for all (or a subset of) past bookings and their respective impressions.

It may then be determined whether the error is minimized between the estimated booking prices and the actual booking prices in operation 406. For instance, the booking price that is estimated for a particular past booking is compared to the price actually paid for such particular booking to determine an error or difference value. An error value may be determined for all (or a subset of) past bookings. Any suitable criteria may be used to determine whether the error is minimized in operation 404. For example, it may be determined whether an average error falls below a predefined error amount or percentage difference. In another implementation, it may be determined whether each error between past booking prices and their corresponding estimated prices falls below a predefined error amount or percentage difference.

If it is determined that the error is not yet minimized, one or more parameter values of the model function may be adjusted in operation 408. For example, one or more parameter values, such as p₁ through pₙ, may be adjusted so that different parameter values are used for one or more attribute values, α. Additionally, different attribute values, α, may be combined and associated with different parameter values, p, as part of the model adjustment operation 408.

When it is determined that the error has been minimized, the model may then be output for use in determining the delivery cost of individual impression predicted for a new product in operation 410, and the model determination process ends. A model may be readjusted periodically so as to tailor the model to changing advertisement conditions. Additionally, the model may be readjusted each time a new product price is needed or requested.

Certain embodiments of the present invention provide a pricing system that facilitates a transition to pricing based on exchange prices, which may allow a very fine-grained measurement of the value of individual impressions. This scheme may also allow finely targeted products to be priced more accurately. Certain embodiments of this approach can also emphasize use and integration of information from multiple sources, as well as from experimentation results. As a result, this approach can be both practical to implement and be robust against noise effects in the data. In certain embodiments, the delivery cost of individual impression may be modeled as a function of impression attributes, as well as the attributes of the advertising contract that it serves (since the individual impressions that are forecast to serve the particular contract are used to determine a contract's delivery cost). Since it may be assumed that the price paid for a contract is equal to the sum of values of individual impressions on average, historic contract prices and the attributes of impressions served against each contract can be used to estimate the model.

Accordingly, certain embodiments allow a more realistic valuation of a product that is based on individual impression attributes and the contract that such individual impressions will be served against. This approach allows guaranteed contracts with new allocation to be priced appropriately. Additionally, a better understanding of how advertisers value different attributes of online advertising inventory may also be determined, even if such advertisers do not specify those attributes in their contract or contract negotiation. Advertisers who consistently obtain better value for their inventory delivery, as compared to other advertisers, can also be identified.

### Forecasting

For predictions to be made in general, historical data is retained and used to extrapolate what will likely happen based on what happened in the past. According to one embodiment, historical data may be collected as users perform certain activities with respect to certain web properties. For instance, user data may be collected using cookies for a user who is logged into a service provider so that user targeting particulars can be collected along with information regarding the particular user activities. In another example, a user may download a web browser plug-in that tracks and logs web requests and responses that are sent between the user and particular web property applications. Data may also be compiled into weblogs that are records of traffic to each space compiled each day and provided by the various web servers in the network, e.g., web property servers 107a and 107b of FIG. 1. Historical data may include page view and run view (views that are made from a particular page view) histories for each major space.

An impression inventory forecaster may be provided that receives queries from an application to obtain an inventory forecast of advertisement impressions for targeting certain user profiles and returns the inventory forecast of the advertisement impressions for targeting user profiles. As used herein, a targeting user profile means one or more attributes associated with one or more users including demographics, online behavior, web page properties, and so forth. A searchable index of advertisement impressions, which are available on certain display advertising properties, may be built for a targeting profile of users from forecasted impression pools. A forecasted impression inventory indexer may generate an index of several index tables from forecasted impression pools to access trend data of forecasted impression inventory by attributes. The index may be searched to match forecasted impression pools for a targeting profile of users submitted in a query for a time period. An inventory forecast of advertisement impressions available on display advertising properties during the time period may be returned as query results for the targeting profile of attributes of users.

In one forecasting technique, historical impressions of advertisements served to online users may initially be retrieved from impression logs. In one embodiment, the impression logs may include recorded information of advertisement impressions that have been served. Impression pools with unique attributes may be created from impression logs. In one embodiment, an impression pool represents a collection of advertisement impressions that share the same attributes, such as web page attributes including properties of the web page and the web page position of an advertisement, visitor attributes such as age, gender, geographical area of residence (e.g., state or country), behavioral interests, behavior activities, time attributes such as date and hour of the day, and other attributes such as attributes of a browser. An impression pool may also include a count of the total number of impressions in the impression pool.

Samples of historical impressions may be extracted from the impression logs. To save storage and computation time, a subset of the impression logs may be processed and kept in an embodiment that may be used to generate a forecast of inventory of advertisement impressions for targeting user profiles. For example, samples representing 4% of historical impressions may be used. The extracted samples of historical impressions may be assigned to impression pools. An impression pool may be defined by attributes such as time attributes, user demographics attributes, behavior attributes, web page attributes and so forth. A sample advertisement impression may be assigned to one or more impression pools that share the unique attributes of the sample impression. For example, a web page may belong to multiple properties or sub-properties and each of the properties or sub-properties may be listed as its web page attribute.

Trend forecast data may be retrieved for untargeted inventory forecasting of advertisement impressions. Impression pools of sample impressions may be matched to trend forecast for display advertising properties to generate forecasted impression pools. In one embodiment, the attributes from an impression pool may be used to match a web page property or collection of related web pages in an inventory trend forecast table with columns including a web page property or collection of related web pages, web page position of an advertisement, and the ratio of the number of forecasted impressions on a given date to the number of actual impressions on a reference date in the past. Each forecasted impression pool may include the information from an impression pool and a pointer to a row in the inventory trend table for a matching display advertising property.

An index of index tables may be built for the forecasted impression pools. In a specific application, there may be millions of forecasted impression pools, each of which may contain dozens or even hundreds of attributes. An efficient indexing technology known in the art, such as FastBit, may be used in one implementation to scan the forecasted impression pools and build an index table for each attribute value. The index of index tables may then be stored for the forecasted impression pools.

Once the index tables are built, the data can be queried very efficiently. A query specifying a targeting profile of attributes of users and a time period may be received. For instance, a query may specify the following attributes of a targeting profile: “property=Finance”, “age>30”, and “country=US”. The time period may be specified as a data range such as “Jul. 1, 2009 to Dec. 31, 2009”. The index may be searched to find forecasted impression pools that match the targeting profile of attributes of users.

An inventory forecast may be determined by summing trend forecast data during the time period specified in the query for each matching forecasted impression pool. In one embodiment, for each date in the time period specified in the query, the trend forecast data may be computed for each matching impression pool and then it may be added to the total inventory forecast. The inventory forecast of advertisement impressions available on display advertisement properties available during the time period may be output for targeting the profile of attributes of users.

The forecast of an inventory of online advertisement impressions may be generated to target many different user profiles. For instance, web page attributes such as properties of the page and the web page position of an advertisement may be used. User attributes for online behavior and/or demographics including age, gender, and country, may be used for targeting user profiles. Or user profiles may be targeted by time, browser attribute or type, and so forth. Certain embodiments may provide accurate forecasting for any combination of thousands of targeting attributes. Thus, certain embodiments may provide a publisher with the capability to forecast available inventories of advertisement impressions for targeting different combinations of attributes before selling them to online advertisers who would like to target users visiting certain web pages with certain demographics, geographies, behavioral interests, as well as many other attributes.

Other forecasting techniques may be used herein and modified to forecast individual impressions for a particular impression request, such as the forecasting techniques that are further described in U.S. application, having Publication No. 2005/0050215 A1, published 3 Mar. 2005, by Long-Ji Lin et al., entitled “Systems and Methods for Predicting Traffic on Internet Sites”, which patent application is incorporated herein by reference in its entirety for all purposes.

### Computer System

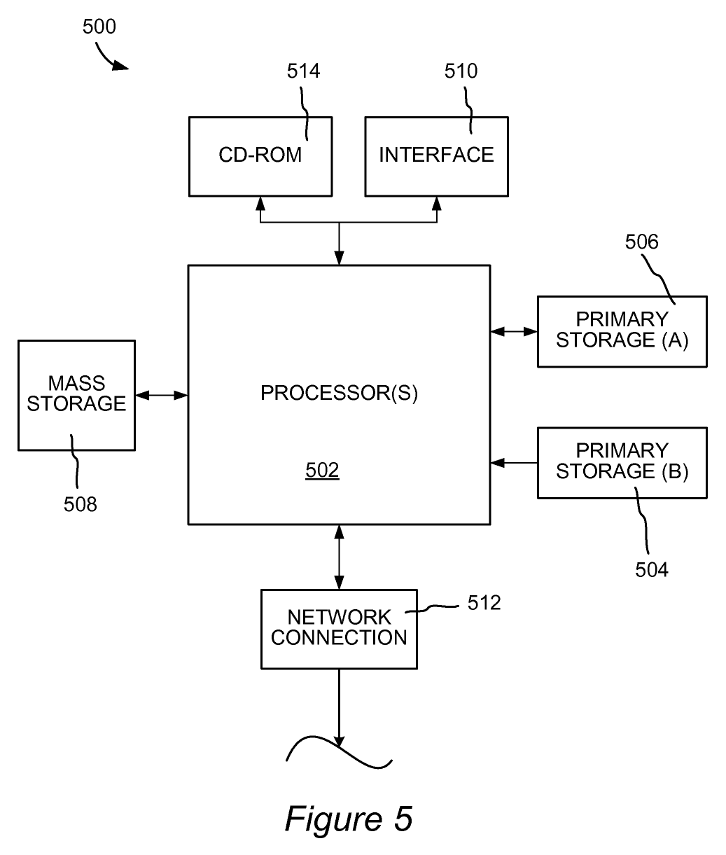

FIG. 5 illustrates a typical computer system that, when appropriately configured or designed, can serve as an advertisement pricing system. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers and microprocessors such as programmable devices (e.g., CPLDs and FPGAs) and unprogrammable devices such as gate array ASICs or general-purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described herein. A mass storage device 508 is also coupled bi-directionally to CPU 502 and provides additional data storage capacity and may include any of the computer-readable media described herein. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 is also coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications network using an external connection as shown generally at 512. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store exchange data, current delivery data, supply and demand forecast data, market forecast data, historical GD transaction data, historic bookings and market data, booking curves, demand elasticity, new bookings, impression attributes, booking prices, booking flight dates, booking durations, number of impressions for each booking, forecast impressions that cover each booking, supply and demand information, models and model parameters, estimated booking prices, error values between estimated and actual booking delivery costs, baseline prices, baseline premiums, target prices, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for pricing on-line advertisement inventory, comprising:
forecasting a delivery cost for delivering a plurality of deliverable impressions to meet a guaranteed delivery contract for a particular advertising product; and
determining a target price for a guaranteed delivery contract for such particular advertising product by adjusting the delivery cost based on one or more changes in one or more conditions of a supply and demand market.

2. The method of claim 1, wherein forecasting the delivery cost is based on historical data from an exchange market in which impressions are sold.

3. The method of claim 2, wherein the exchange market includes the selling of impressions for guaranteed delivery (GD) contracts and impressions that are not applied to guaranteed delivery contracts.

4. The method of claim 3, further comprising applying to each deliverable impression a statistical model for determining a delivery cost of an individual impression in the exchange market as a function of such individual impression's user target attributes based on historical bookings for a plurality of historical impressions, wherein the delivery cost of the advertising product is forecast by averaging the delivery costs for the deliverable impressions as determined by the statistical model.

5. The method of claim 1, further comprising scaling up the delivery cost by a premium factor so as to account for additional value of inventory for GD contracts vs. NGD contracts.

6. The method of claim 1, further comprising adjusting the delivery cost in response to historical and current booking rates for the advertising product.

7. The method of claim 1, further comprising adjusting the delivery cost in response to one or more demand elasticity estimates for the advertising product.

8. The method as recited in claim 1, further comprising:
using the determined target price, which was based on historical bookings, to determine a current target price of the new product; and
returning the current target price of the new product for use in a booking negotiation with a potential buyer of such new product.

9. An apparatus comprising at least a processor and a memory, wherein the processor and/or memory are configured to perform the following operations:
forecasting a delivery cost for delivering a plurality of deliverable impressions to meet a guaranteed delivery contract for a particular advertising product; and
determining a target price for a guaranteed delivery contract for such particular advertising product by adjusting the delivery cost based on one or more changes in one or more conditions of a supply and demand market.

10. The apparatus of claim 9, wherein forecasting the delivery cost is based on historical data from an exchange market in which impressions are sold.

11. The apparatus of claim 10, wherein the exchange market includes the selling of impressions for guaranteed delivery (GD) contracts and impressions that are not applied to guaranteed delivery contracts.

12. The apparatus of claim 11, wherein the processor and/or memory are further configured to apply to each deliverable impression a statistical model for determining a delivery cost of an individual impression in the exchange market as a function of such individual impression's user target attributes based on historical bookings for a plurality of historical impressions, wherein the delivery cost of the advertising product is forecast by averaging the delivery costs for the deliverable impressions as determined by the statistical model.

13. The apparatus of claim 9, wherein the processor and/or memory are further configured to scale up the delivery cost by a premium factor so as to account for additional value of inventory for GD contracts vs. NGD contracts.

14. The apparatus of claim 9, wherein the processor and/or memory are further configured to adjust the delivery cost in response to historical and current booking rates for the advertising product.

15. The apparatus of claim 9, wherein the processor and/or memory are further configured to adjust the delivery cost in response to one or more demand elasticity estimates for the advertising product.

16. The apparatus as recited in claim 9, wherein the processor and/or memory are further configured to perform the following operations:
using the determined target price, which was based on historical bookings, to determine a current target price of the new product; and
returning the current target price of the new product for use in a booking negotiation with a potential buyer of such new product.

17. At least one computer readable storage medium having computer program instructions stored thereon that are arranged to perform the following operations:
forecasting a delivery cost for delivering a plurality of deliverable impressions to meet a guaranteed delivery contract for a particular advertising product; and
determining a target price for a guaranteed delivery contract for such particular advertising product by adjusting the delivery cost based on one or more changes in one or more conditions of a supply and demand market.

18. The at least one computer readable storage medium of claim 17, wherein forecasting the delivery cost is based on historical data from an exchange market in which impressions are sold.

19. The at least one computer readable storage medium of claim 18, wherein the exchange market includes the selling of impressions for guaranteed delivery (GD) contracts and impressions that are not applied to guaranteed delivery contracts.

20. The at least one computer readable storage medium of claim 19, wherein the computer program instructions are further arranged to apply to each deliverable impression a statistical model for determining a delivery cost of an individual impression in the exchange market as a function of such individual impression's user target attributes based on historical bookings for a plurality of historical impressions, wherein the delivery cost of the advertising product is forecast by averaging the delivery costs for the deliverable impressions as determined by the statistical model.

21. The at least one computer readable storage medium of claim 17, wherein the computer program instructions are further arranged to scale up the delivery cost by a premium factor so as to account for additional value of inventory for GD contracts vs. NGD contracts.

22. The at least one computer readable storage medium of claim 17, wherein the computer program instructions are further arranged to adjust the delivery cost in response to historical and current booking rates for the advertising product.

23. The at least one computer readable storage medium of claim 17, wherein the computer program instructions are further arranged to adjust the delivery cost in response to one or more demand elasticity estimates for the advertising product.

24. The at least one computer readable storage medium as recited in claim 17, wherein the computer program instructions are further arranged to perform the following operations:
using the determined target price, which was based on historical bookings, to determine a current target price of the new product; and
returning the current target price of the new product for use in a booking negotiation with a potential buyer of such new product.
